(19) United States
(12) Patent Application Publication
(10) Pub. No.: US 2008/0089194 A1
(43) Pub. Date: Apr. 17, 2008

(54) Optical pickup, optical disk drive, optical information recording/replaying device, and tilt adjusting method

(76) Inventors: Keiichi Matsuzaki, Osaka (JP); Hidenori Wada, Kyoto (JP); Yukihiro Chokyu, Ehime (JP); Hideki Aikoh, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/905,599

(22) Filed: Oct. 2, 2007

(30) Foreign Application Priority Data
Oct. 2, 2006 (JP) 2006-270384

(51) Int. Cl. G11B 7/00

(52) U.S. Cl. 369/44.32

(57) ABSTRACT

There is provided a tilt correction processing method which can reliably detect the amount of tilt in a short time and adjust it, and then recording or replaying is started in a short time by employing the same. To perform recording or replaying to plural optical information media, an optical pickup having one or a plurality of light sources; one or a plurality of objective lenses for focusing light from the light source onto the optical information medium; an objective lens actuator which can control the objective lens in a focus direction and in a tracking direction and control the tilt of the objective lens; an optical information medium discriminating unit for discriminating a type of an optical disk when recording or replaying is performed to the optical disk; and an objective lens tilt setting unit for tilting the objective lens with respect to at least one of the optical information media by a predetermined amount by the objective lens actuator based on the discriminated result of the type of the optical information medium.

### FIELD OF THE INVENTION

The present invention relates to an optical disk device which records or replays information onto/from an optical information medium, typified by an optical disk. More specifically, the present invention relates to an optical pickup, an optical disk drive, and an optical information recording/replaying device, having one or a plurality of light sources and capable of performing recording or replaying to a plurality of types of optical information media by the light source or the light sources, and a tilt adjusting method.

### DESCRIPTION OF THE RELATED ART

In recent years, optical disk devices have been actively developed as means for recording or replaying a large amount of data. An attempt has been made to achieve a higher recording density.

In addition to a conventional CD (Compact Disk) and DVD (Digital Versatile Disk), with the increased recording capacity of an optical information medium, there have recently been in practical use a single-sided single-layer Blu-ray Disc which can record or replay digital information of about 25 GB, a single-sided dual-layer Blu-ray Disc which can record or replay digital information of about 50 GB, a single-sided single-layer HD-DVD (High Definition DVD) which can record or replay digital information of about 20 GB, and a single-sided dual-layer HD-DVD which can record or replay digital information of about 40 GB.

To achieve such high recording density, an S/N ratio and interference between recorded pits need be improved and a signal quality need be compensated for variations in an optical disk medium and an optical disk device. In particular, this is pointed out as the change of a replaying channel characteristic due to defocus, off-track (a deviation of an optical spot from the center of a track), a tangential tilt (a tilt in the recording track tangential direction), and a radial tilt (a tilt in a disk radial direction), typified as variations in the position relation between an optical head and an optical disk medium. An optical disk device which can suppress increase in error rate caused by these has been required.

In an optical disk device which records or replays information onto/from a recording or replaying layer formed on an optical disk as an optical information medium, if the tangential tilt and the radial tilt occur due to warping of the disk or a clamping error, a coma aberration can be caused on a focal spot onto an information recording surface of the optical disk.

As means for reducing deterioration of a recording or replaying performance due to disk tilt with respect to an optical axis of a laser beam, a tilt adjustment and a tilt control for detecting the amount of the tilt to correct for the coma aberration need be performed.

Techniques about the tilt adjustment and the tilt control have been already proposed and have been in practical use.

A conventional optimum radial tilt control method will be described here using FIG. 17.

FIG. 17 is a block diagram of radial tilt control of a conventional optical disk recording device.

In FIG. 17, the optical disk recording device includes an optical disk 201, a pickup module 202, a spindle motor 203, a focus driving coil 204, an objective lens 205, a reflection light receiving unit 206, a laser diode as a light source 207, a reflection light computing unit 208, a reflection light A/D converting unit 209, a reflection light A/D conversion value comparing unit 210, a radial tilt control unit 211, a focus driving unit 212. A conventional processing for searching for an optimum radial tilt in the thus configured radial tilt control block will be described.

The optical disk recording device into which the optical disk 201 is inserted rotates the spindle motor 203 at a predetermined rotational speed and illuminates the laser diode 207 so as to be focus servoed and tracking servoed. The pickup module is moved to the emboss zone on the innermost circumference of the disk. The replaying operation is then performed in the emboss zone. The reflection light from the optical disk 201 is received by the reflection light receiving unit 206. The signal received by the reflection light receiving unit 206 is computed to an RF signal as the sum of the reflection light by the reflection light computing unit 208. The obtained RF signal is A/D converted by the reflection light A/D converting unit 209. The signal amplitude of the RF signal is measured to hold a pair of the RF signal amplitude value and the current radial tilt value. In the same processing, the signal which tilts the objective lens 205 is outputted from the radial tilt control unit 211 to the focus driving unit 212, and then, each RF signal amplitude is measured for variation of five radial tilts.

FIG. 18A shows a diagram showing the relation between the radial tilts and the RF signal amplitudes. As shown in FIG. 18B, when the radial tilt of the objective lens is performed in the radial direction, the radial tilt values and the RF signal amplitude values corresponding to them, which are obtained by five tilts, are the points shown in FIG. 18A. When these points are parabola-approximated using the least squares method, a mountain-shaped parabola is obtained. Therefore, the top of the parabola is determined as an optimum radial tilt value.

Other than the determining method in which the RF signal is maximum, to search for an optimum radial tilt, there are a method of searching for it from the change in focus driving voltage, as disclosed in Japanese Patent Application Laid-Open No. 2001-195763 and a method of searching for a radial tilt in which an error rate and a jitter value are minimum, as disclosed in Japanese Patent Application Laid-Open No. 2003-263764.

The optical system of an optical pickup which performs recording or replaying to an optical disk has aberration due to a processing accuracy of optical components and misalignment at an assembling of the optical pickup.

The aberration affects the quality of a focal spot by an objective lens and greatly affects the recording/replaying characteristic of the optical disk. Therefore, it is necessary to configure an optical system having very small aberration.

Generally used method is a method of canceling and reducing the coma aberration as the component of the aberration by tilting an objective lens with respect to a reference disk at an assembling adjustment. As a result, the objective lens is tiltably arranged. Hereinafter, the tilt at the assembling adjustment is represented as an objective lens initial tilt.

It has been widely known that a coma aberration caused by a relative tilt of the objective lens and the reference disk is in proportion to a cube of an NA (numerical aperture) of the objective lens, a protective layer thickness of the information recording surface of the optical disk, and an inverse number of a wavelength, respectively. FIG. 19 shows the amount of the coma aberration caused by the relative tilt of the objective lens and the reference disk with respect to the currently and typically used optical disks (BD, HD-DVD, DVD, and CD). The amount of the coma aberration caused by the relative tilt of the objective lens and the reference disk is represented as a disk tilt sensitivity of the coma aberration.

In a current optical disk drive device, there are typically used a combo drive, a multi-drive, a super multi-drive, and a hyper multi-drive, for performing recording or replaying to a plurality of types of optical disks. It is essential that recording or replaying be performed to the plurality of types of optical disks by a single optical pickup.

The optical pickup in this case has different optical system configurations. For example, there is used a configuration in which the optical axis of light emitted from a light source for the CD and DVD is focused by a prism and the light is then passed through the shared optical path so as to be focused onto an optical disk surface by a shared objective lens.

To perform recording or replaying to the Blu-ray disk, there has been in practical use a method in which, in addition to a first objective lens for the CD and DVD, a second objective lens is provided to the shared objective lens actuator. A bluish purple laser beam as a light source is focused onto the optical disk surface by the second objective lens to record or replay digital information.

It is considered that a pickup which can perform recording or replaying to the Blu-ray disk and the HD-DVD will be in practical use in the future. In this case, there is considered an optical pickup which is configured by a shared light source and optical system by employing optical arrangement for correcting for optical difference due to the numerical aperture and the substrate thickness between the Blu-ray disk and the HD-DVD.

It is also considered that there will be in practical use a method in which the optical axis of light emitted from a light source for the CD, DVD, Blu-ray disk, and HD-DVD is focused by a prism and the light is then passed through a shared optical path so as to be focused onto the optical disk surface by the shared objective lens by employing optical arrangement for correcting for optical difference due to the numerical aperture and a substrate thickness.

In the optical pickup for any plurality of optical disks of the CD, DVD, Blu-ray disk, and HD-DVD, the amount of a coma aberration of the optical system corresponding to the respective optical disks is different due to an aberration of the components of the optical system. As shown in FIG. 19, the disk tilt sensitivity of the coma aberration is varied due to a difference in the numerical aperture of the objective lens corresponding to the respective optical disks, the protective layer thickness of the information recording surface of the optical disk, and the wavelength. The angle which corrects for the coma aberration is different between the respective optical disks. The objective lens initial tilt is different.

Consider that the pickup which can perform recording or replaying to the Blu-ray disk and the HD-DVD is configured by the shared light source and optical system.

As the optical system and the light source are shared, coma aberration of the optical system of the Blu-ray disk is substantially the same as that of the HD-DVD. However, as shown in FIG. 19, the disk tilt sensitivity of the coma aberration is different 2.7 times between the Blu-ray disk and the HD-DVD. The objective lens initial tilt of the Blu-ray disk is different 2.7 times from that of the HD-DVD.

As the objective lens is shared, the objective lens initial tilt at the assembling adjustment cannot be set so as to be optimum for both the Blu-ray disk and the HD-DVD. An optical system for at least one of the disks is assembled while the coma aberration remains.

In the conventional art, the optimum value of the amount of initial tilt is detected each time each optical disk is mounted to adjust the initial tilt based on the detection value. The deterioration in the recording or replaying performance due to the remaining coma aberration can be reduced.

As described above, when the method of adjusting the amount of initial tilt based on the detected jitter is performed each time each optical disk is mounted, it takes long time to do that. Time for the optical disk device to start recording or replaying becomes longer.

In view of the above conventional problems, an object of the present invention is to provide a tilt correction processing method which can reliably detect the amount of the tilt in a short time and adjust it, an optical pickup, an optical disk drive, and an optical information recording/replaying device, capable of start recording or replaying in a short time by employing the same, and a tilt adjusting method.

To address the above technical problems, the present invention provides optical pickups of the following configuration.

### DISCLOSURE OF INVENTION

In accomplishing these and other aspects, according to a first aspect of the present invention, there is provided an optical pickup for performing recording or replaying to a plurality types of optical information media, comprising:

one or a plurality of light sources;

an objective lens for focusing light from the light source onto the optical information medium;

an objective lens actuator for moving the objective lens in a focus direction and in a tracking direction and changing a tilt of an optical axis of the objective lens;

an optical information medium discriminating unit for discriminating the type of the optical information medium at a start of recording or replaying to the optical information medium;

a tilt angle storing unit having tilt information having information on the tilt of the objective lens according to the type of the optical information medium; and

an objective lens tilt setting unit for driving and controlling the objective lens actuator so as to tilt the objective lens to an angle set based on the tilt information of the tilt angle storing unit based on the discriminated result of the type of the optical information medium by the optical information medium discriminating unit.

According to a second aspect of the present invention, there is provided an optical pickup for performing recording or replaying to a plurality of types of optical information media, comprising:

one or a plurality of light sources;

an objective lens for focusing light from the light source onto the optical information medium;

an objective lens actuator for moving the objective lens in a focus direction and in a tracking direction;

an optical information medium discriminating unit for discriminating the type of the optical information medium at a start of recording or replaying to the optical information medium;

an aberration correction device for correcting for aberration of light emitted from the objective lens;

an aberration correction value storing unit having aberration information storing information on the correction value of the aberration of the light according to the type of the optical information medium; and

a coma aberration setting unit for offsetting a coma aberration of the emitted light of the objective lens by a fixed amount by driving and controlling the aberration correction device to the correction value set by the aberration information of the aberration correction value storing unit based on the discriminated result of the type of the optical information medium by the optical information medium discriminating unit.

According to a third aspect of the present invention, there is provided an optical pickup for performing recording or replaying to a plurality of types of optical information media, comprising:

one or a plurality of light sources;

an objective lens for focusing light from the light source onto the optical information medium;

an objective lens actuator for moving the objective lens in a focus direction and in a tracking direction and changing a tilt of the optical axis of the objective lens;

an optical information medium discriminating unit for discriminating the type of the optical information medium at a start of recording or replaying to the optical information medium;

a tilt angle storing unit having tilt information having information on the tilt of the objective lens according to the type of the optical information medium;

an objective lens tilt setting unit for driving and controlling the objective lens actuator so as to tilt the objective lens to an angle set based on the tilt information of the tilt angle storing unit based on the discriminated result of the type of the optical information medium by the optical information medium discriminating unit;

a driving state detecting unit for detecting the recording or replaying state of the optical information medium; and

a coma aberration correcting unit for offsetting the coma aberration of the emitted light of the objective lens by a fixed amount by driving and controlling the aberration correction device according to the driving state by the driving state detecting unit.

According to a fourth aspect of the present invention, there is provided an optical pickup for performing recording or replaying to a plurality of types of optical information media, comprising:

one or a plurality of light sources;

an objective lens for focusing light from the light source onto the optical information medium;

an objective lens actuator for moving the objective lens in a focus direction and in a tracking direction and change a tilt of the optical axis of the objective lens;

an optical information medium discriminating unit for discriminating the type of the optical information medium at a start of recording or replaying to the optical information medium;

an aberration correction device for correcting for aberration of light emitted from the objective lens;

an aberration correction value storing unit having aberration information storing information on the correction value of the aberration of the light according to the type of the optical information medium;

a driving state detecting unit for detecting the recording or replaying state of the optical information medium; and

a tilt correction control unit for driving and controlling the objective lens actuator so as to tilt the objective lens according to the driving state by the driving state detecting unit.

According to the respective aspects of the present invention, when each of the plurality of optical disks is mounted, the initial tilt of the optical axis of light emitted from the objective lens is optimized immediately. Therefore, the tilt adjustment which calculates the optimum amount of a tilt correction can be executed in a short time. Thus, time for the optical disk device to start recording or replaying can be shortened and the recording or replaying performance with respect to the amount of disk tilt can be improved.

### BRIEF DESCRIPTION OF DRAWINGS

These and other aspects and features of the present invention will become clear from the following description taken in conjunction with the preferred embodiments thereof with reference to the accompanying drawings, in which:

FIG. 1 is a perspective view showing an appearance configuration of an optical pickup according to an embodiment of the present invention;

FIG. 2 is an exploded perspective view of the optical pickup of FIG. 1;

FIG. 3 is a schematic diagram schematically showing the configuration of the optical system of the optical pickup of FIG. 1;

FIG. 4 is a diagram showing the inner configuration of an optical base used for the optical pickup of FIG. 1;

FIG. 5A is a plan view showing the configuration of an objective lens actuator of the optical pickup of FIG. 1;

FIG. 5B is a cross-sectional view taken along line VB-VB of FIG. 5A;

FIG. 6 is an exploded perspective view of the objective lens actuator of FIG. 5A;

FIG. 7 is a block diagram noting an operation function of an optical disk device equipped with the optical pickup of FIG. 1;

FIG. 8 is a flowchart showing the operation of the optical disk device of FIG. 7;

FIG. 9 is a diagram showing a positional relation between an objective lens and a first optical disk when the first optical disk is mounted to generate a focus error signal;

FIG. 10 is a diagram showing a positional relation between the objective lens and a second optical disk when the second optical disk is mounted to generate a focus error signal;

FIG. 11A is a timing chart showing focus error signals and S-shaped detection signals corresponding to FIGS. 9 and 10;

FIG. 11B is a timing chart showing focus error signals and S-shaped detection signals corresponding to FIGS. 9 and 10;

FIG. 12 is a diagram showing the structures of information on the optimum amount of a tilt correction stored in a memory;

FIG. 13 is a diagram showing a configuration example of a variable resistor of an electronic circuit which changes the control current of an actuator;

FIG. 14 is a block diagram noting an operation function of an optical disk device according to a second embodiment;

FIG. 15 is a block diagram noting an operation function of an optical disk device according to a third embodiment;

FIG. 16 is a block diagram noting an operation function of an optical disk device according to a fourth embodiment;

FIG. 17 is a radial tilt control block diagram of a conventional optical disk recording device;

FIG. 18A is a diagram showing a relation between radial tilts and RF signal amplitudes;

FIG. 18B is a diagram showing a relation between radial tilts and an objective lens; and

FIG. 19 is a diagram showing the amount of a coma aberration caused by a relative tilt of an objective lens and reference disks.

### BEST MODE FOR CARRYING OUT THE INVENTION

Before the description of the present invention proceeds, it is to be noted that like parts are designated by like reference numerals throughout the accompanying drawings.

Embodiments of the present invention will be described below in detail with reference to the accompanying drawings.

Before describing the embodiments of the present invention, the definition of the coordinate axes of an optical pickup according to this embodiment will be clarified. A T axis is vertical to an optical axis of an objective lens and is directed in a substantially vertical direction with respect to a track groove extension direction of an optical disk and in a direction moving the optical pickup (tracking direction) at a recording and replaying on an inner circumference and an outer circumference of the optical disk. An F axis is directed in an optical axis direction of the objective lens, that is, a focusing direction. A Y axis is directed in the vertical direction with respect to the T axis and in a substantially parallel direction with respect to the track groove extension direction of the optical disk.

### FIRST EMBODIMENT

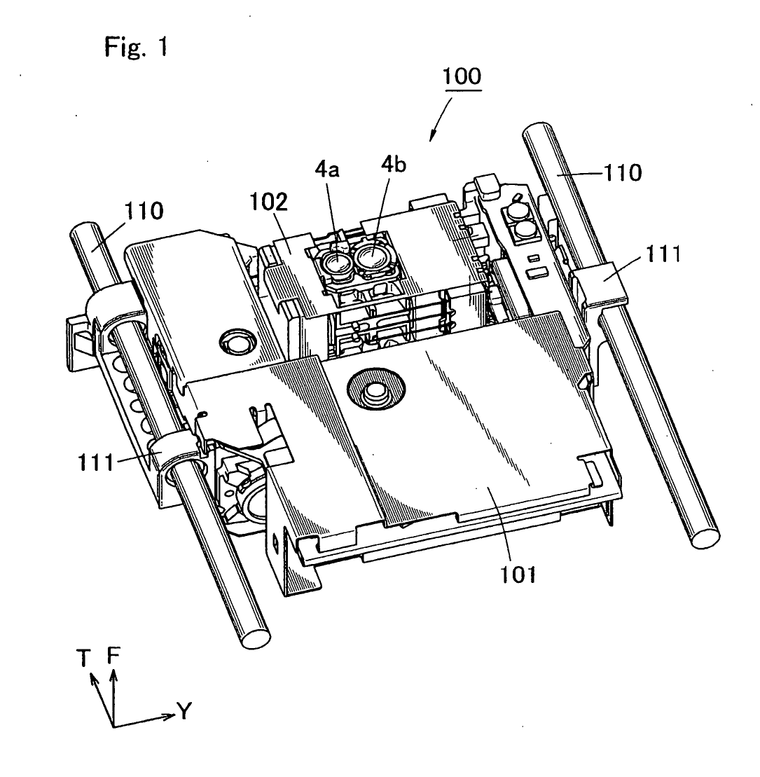

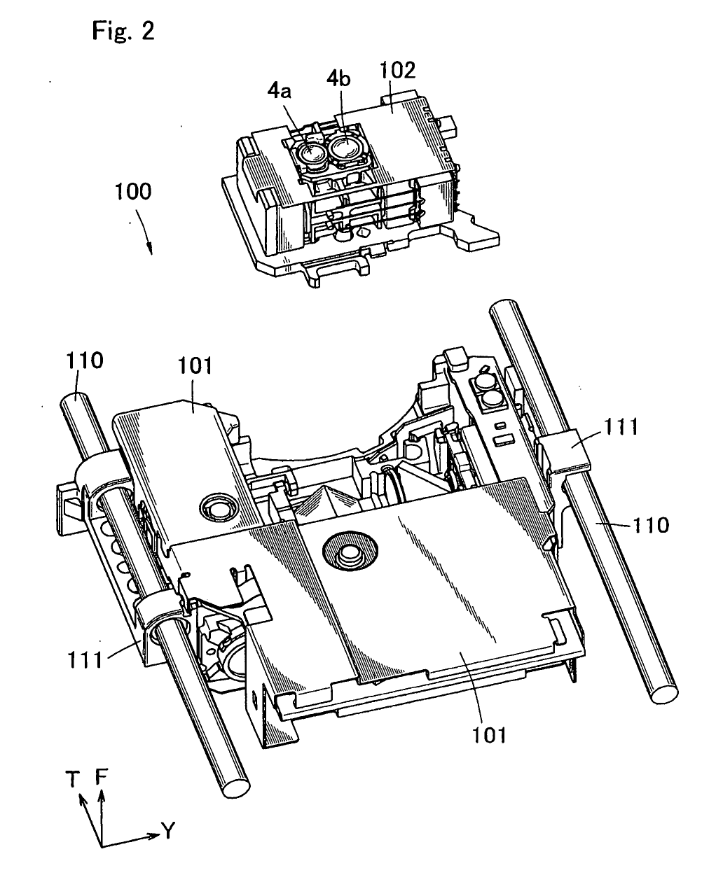

FIG. 1 is a perspective view showing an appearance configuration of an optical pickup according to an embodiment of the present invention. FIG. 2 is an exploded perspective view of the optical pickup of FIG. 1. An optical pickup 100 has an optical base 101 and an objective lens actuator 102 fixed onto an illustrated upper side of the optical base 101. The optical base 101 is engaged with a set of guide rails 110 by engaging portions 111 positioned at both ends in a Y axis direction and can be moved in the tracking direction along the guide rails 110.

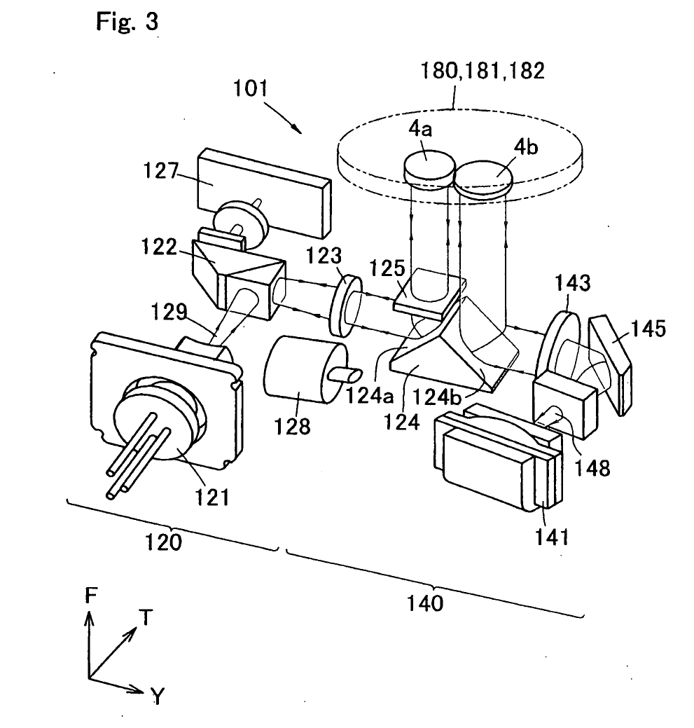

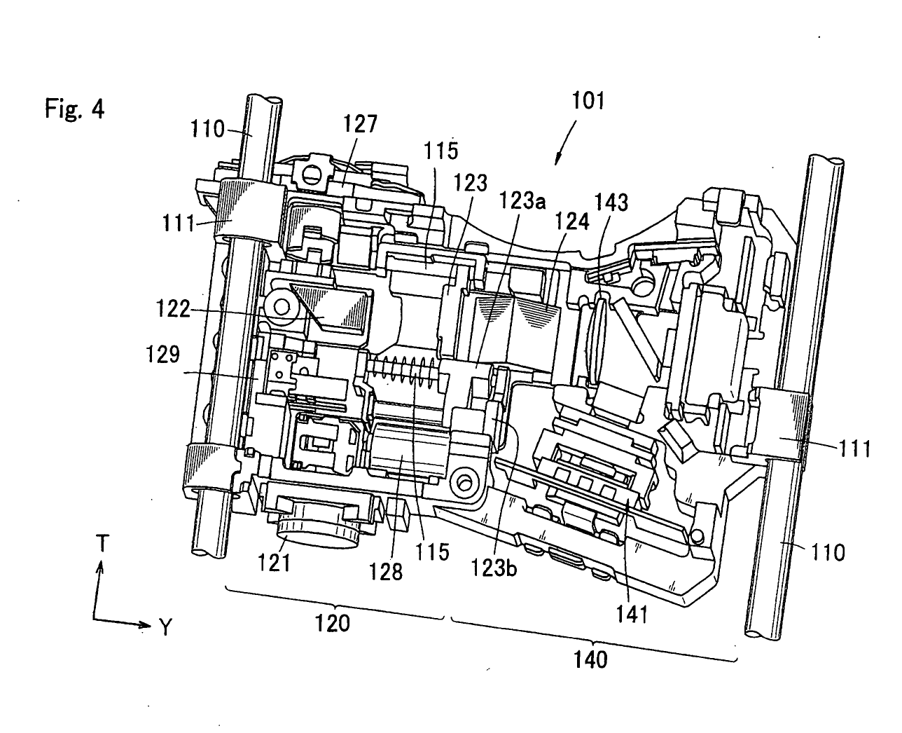

FIG. 3 is a schematic diagram schematically showing a configuration of an optical system of the optical pickup of FIG. 1. FIG. 4 is a diagram showing an inner configuration of the optical base used for the optical pickup of FIG. 1. The members configuring the optical system of the optical pickup are mounted on the optical base 101 and the objective lens actuator 102.

The optical pickup 100 according to this embodiment has a first optical system 120 and a second optical system 140. The first optical system 120 is an optical system for performing recording or replaying to a next generation optical disk 180, such as a Blu-ray disk or HD-DVD. The second optical system 140 is an optical system for performing recording or replaying to a DVD 181 and a CD 182.

As described later, the HD-DVD has a characteristic in which its substrate thickness and numerical aperture are approximate to those of the DVD 181. Recording or replaying to the HD-DVD may be performed by the second optical system 140.

The first optical system 120 will be described. A first light source 121 of the first optical system 120 emits an optical beam 129 having a wavelength of 405 nm. The optical beam 129 emitted from the first light source 121 is bent by a polarization beam splitter 122 to reach a collimate lens 123. The optical beam 129 which has passed through the polarization beam splitter 122 is linearly polarized light. Its divergence is converted by the collimate lens 123. The optical axis of the optical beam is bent in a direction normal to the optical disk 180 having a high recording density by a first slope 124a of a rising prism 124 whose section is substantially triangular, as an example of a bending mirror. The optical beam which has been bent by the rising prism 124 passes through a λ/4 wave plate 125, as an example of a wave plate, so as to be circularly polarized light. The optical beam 129 is focused onto a recording surface of the optical disk 180 by an objective lens 126 to form an optical spot.

The first optical beam which has reached the optical disk 180 is reflected on a recording layer of the optical disk 180 at a reflectivity according to the state of the recording layer. The first optical beam which has reflected on the recording layer of the optical disk 180 passes through the objective lens 126 again to reach the λ/4 wave plate 125. The optical beam which has reached the λ/4 wave plate 125 is converted to linearly polarized light orthogonal to a forward-traveling path (that is, the linearly polarized light of the optical beam emitted from the collimate lens 123 to the rising prism 124) when passing through the λ/4 wave plate 125. Then, the optical beam passes through the collimate lens 123 so as to be reflected on the polarization beam splitter 122 by the first reflection plane 124a of the rising prism 124. This optical beam has a change direction different from that of the optical beam on the forward-traveling path and is reflected on the polarization beam splitter 122 so as to be incident on a photodetector 127. The optical beam is photoelectrically converted by the photodetector 127 to take out an electric signal for obtaining an information signal and a servo signal (a focus error signal for focus control and a tracking signal for tracking control).

The objective lens 126 used for the first optical system 120 has a numerical aperture of 0.85 or larger. Due to the large numerical aperture, when recording or replaying is performed to the optical disk 180, spherical aberration noticeably occurs with respect to a thickness of the transparent substrate which satisfies the optical disk from the surface on which light is incident to an information recording surface. In this present embodiment, the collimate lens 123 is moved in the optical axis direction of the collimate lens 123 to change a divergence convergence degree of light from the collimate lens 123 toward the objective lens 126. When the divergence convergence degree of light incident on the objective lens 126 is changed, spherical aberration is varied. Therefore, using this, the spherical aberration caused by the substrate thickness difference is corrected for. The optical base 101 has a driving device having a driving motor 128 as a mechanism for moving the collimate lens 123 in the optical axis direction thereof. As the driving motor 128, specifically, a stepping motor and a brushless motor can be used. As shown in FIG. 4, a holder 123a for holding the collimate lens 123a and a driving mechanism 123b for transmitting the driving force of the driving motor 128 to the holder 123a are provided on the optical base 101. The holder 123a for holding the collimate lens 123 is supported by two guide shafts 115 extended in the optical axis direction of the collimate lens. The collimate lens is moved along the guide shafts 115. To reduce rattle when the collimate lens is moved along the guide shafts 115, the holder 123a biased by the spring is supported by the guide shafts 115. To reduce the number of components, the lens holder 123a may be integrally formed with the collimate lens 123.

The second optical system 140 will be described. In the second optical system 140, a second laser unit 141 is used as a second light source (e.g., red light source). The second laser unit 141 is a member by integrally forming the light source for emitting the laser beam and the photodetector for detecting the laser beam. An optical beam 148 emitted from the second laser unit 141 reaches a half mirror 145. The optical beam 148 is bent by the half mirror 145. Its parallelism is converted (e.g., to substantially parallel beam) by the collimate lens 143. Then the optical beam 148 is led to the rising prism 124. A second slope 124b of the rising prism 124 bends the optical axis in the direction normal to the optical disk 181 (e.g., DVD) having a low recording density. An objective lens 144 focuses the optical beam 148 onto the recording surface of the optical disk 181 to form an optical spot. The optical beam which has been reflected on the recording surface of the optical disk 181 at a reflectivity according to the state of the recording layer reversely traces an original optical path and reaches the second laser unit 141 as the photodetector. The optical beam 148 is photoelectrically converted by the second laser unit 141 to obtain an electric signal for obtaining an information signal and a servo signal (a focus error signal for focus control and a tracking signal for tracking control).

As described above, in the first optical system 120, the light source 121 for emitting the laser beam and the photodetector 127 for detecting the laser beam reflected on the optical disk 180 are configured by separate members. Therefore, the optical path need be changed between the forward-traveling path and a backward-traveling path by the polarization beam splitter 122. The λ/4 wave plate 125 is provided as a member which changes the optical path of the laser beam. When the laser beam passes through the λ/4 wave plate 125, polarization of the laser beam is changed to make the optical path different. On the other hand, in the second optical system, the light source for emitting the laser beam and the detector for detecting the light beam reflected on the optical disks 181 and 182, which are provided for the optical disks 181 and 182, respectively, are united. They are configured of one member as the second laser unit 141. The optical path need not be different between the forward-traveling path and the backward-traveling path. Thus, the polarization of the laser beam need not be changed in the forward-traveling path and the backward-traveling path. Accordingly, the second optical system 140 need not be provided with the λ/4 wave plate.

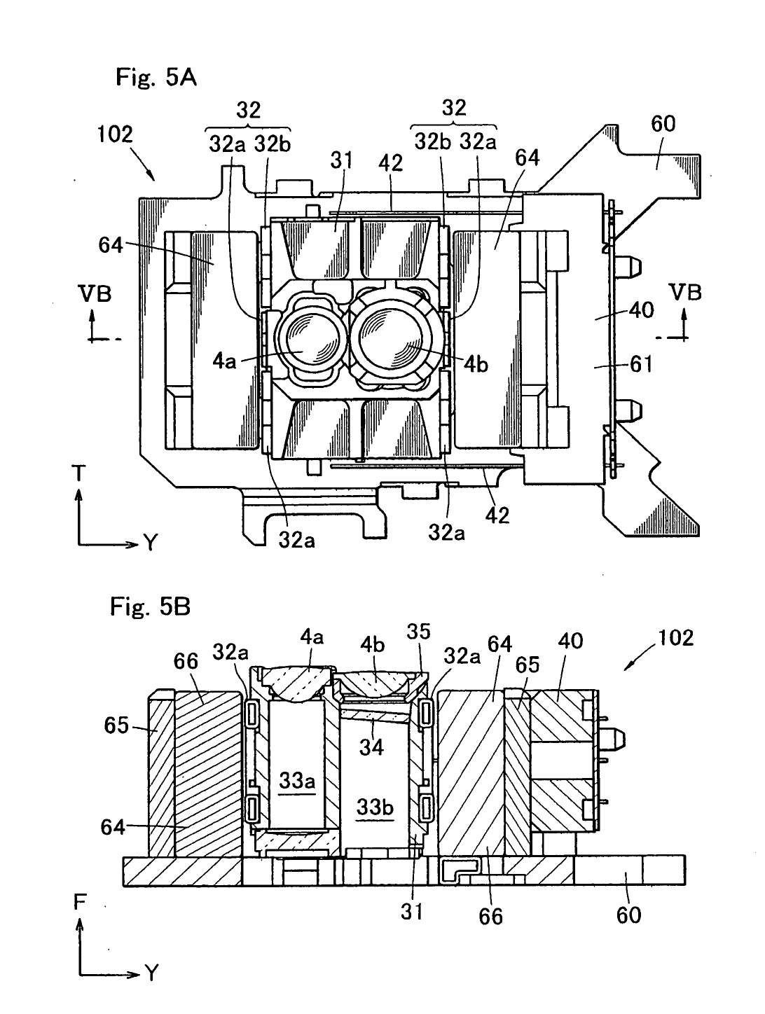

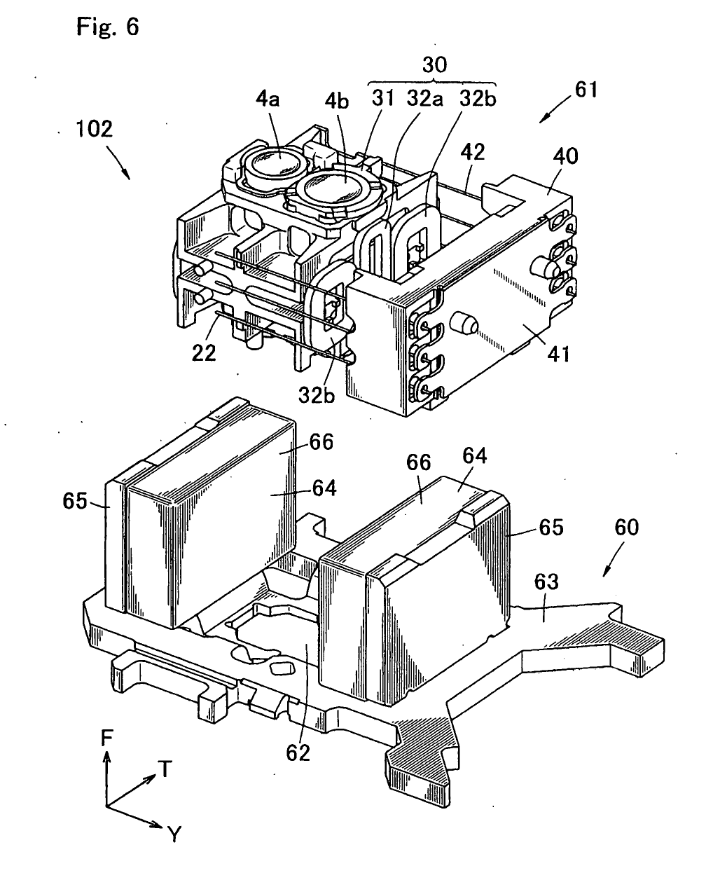

As shown in FIGS. 5A, 5B, and 6, the objective lens actuator 102 has an actuator base 60 and a suspension unit 61.

The actuator base 60 has a pair of magnet portions 64 arranged in parallel with each other so as to be opposite each other in the Y axis direction by interposing an opening 62 therebetween on a base plate 63 having the opening 62 for passing the laser beam reflected by the rising prism 124 in an F axis direction therethrough. The magnet portions 64 have a pair of magnet support portions 65 erected on the base plate 63 and magnets 66 arranged on the surfaces on the opening 62 side of the magnet support portions 65. A moving body 30 of the suspension unit 61 is arranged between the pair of magnet portions 64. As described later, an electric current is supplied to coils 32 of the moving body 30 to perform position adjustment of the moving body 30 of the suspension unit 61. The moving body 30 is moved to move objective lenses 4a and 4b in a focus direction and in the tracking direction. The tilt of the objective lenses can be changed.

The suspension unit 61 has the moving body 30 which can be moved with respect to the actuator base 60 and a sus holder 40 for movably supporting the moving body 30. The moving body 30 is supported by six suspension wires 42 extended from the sus holder 40 and can be moved in a direction in which the six suspension wires 42 are bent with respect to the sus holder 40, that is, in a direction orthogonal to a extension direction of the six suspension wires 42. The suspension unit 61 is assembled to the actuator base 60 in such a manner that the moving body 30 is positioned between the magnets 66 and the sus holder 40 is positioned outside the magnet portions 64.

The moving body 30 has two lens barrels 33a and 33b extended in the F direction. When the suspension unit 61 is assembled to the actuator base 60, the lens barrel 33a of the moving portion 30 is positioned above the wave plate 125. The objective lens 126 is provided on the lens barrel 33a of the first optical system 120. An objective lens 144 is provided on the lens barrel 33b of the second optical system 140. A hologram device 34 is provided in the lens barrel 33b of the second optical system 140 and diffracts and divides part of the laser beam reflected on the optical disk of the second optical system 140 to generate the focus error signal or the tracking error signal.

As shown in FIG. 5B, the objective lens 144 for the second optical system 140 fixed to an objective lens holder 35 is fixed to the moving body 30. The objective lens holder 35 has a taper surface on the lens barrel 33b side. The mounting angle can be adjusted at the fixing to the lens barrel 33b. A fixing direction of the objective lens 144 and the moving body 30 can be adjusted from the following reason. When the two objective lenses 126 and 144 are fixed to the moving body 30, the objective lenses 126 and 144 of the two optical systems 120 and 140 need be finely adjusted in the optical axis direction. Therefore, in this embodiment, while the objective lens 126 for the first optical system 120 is reference, the objective lens 144 for the second optical system 140 is finely adjusted. Accordingly, both the optical systems can be finely adjusted.

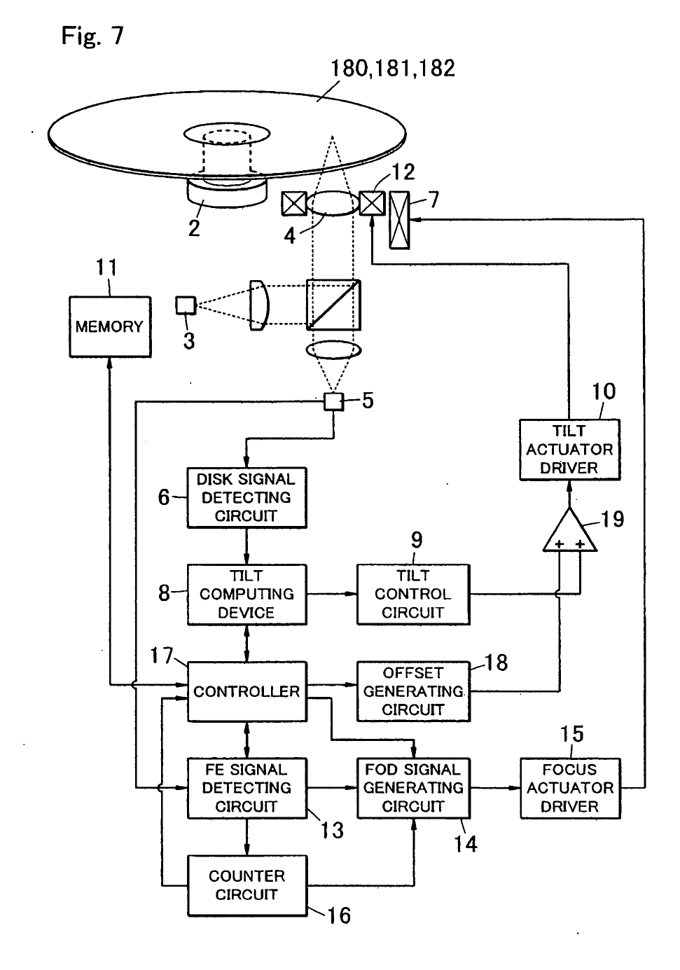

The objective lens 126 for the first optical system 120 and the objective lens 144 for the second optical system are held by the moving body 30 in the state that they are arranged so as to be substantially parallel with each other, in the Y direction, that is, in the track groove extension direction of the optical disk. When the two objective lenses are arranged in the direction normal to the track groove extension direction and are moved to an outermost circumference or an innermost circumference of the optical disk, the inside objective lens not used can interfere with a spindle motor 164 (see FIG. 7A) for rotating the optical disks 181 and 182 and the outside lens can interfere with the exterior of the optical disk device. The objective lenses 126 and 144 are arranged in the Y direction, whereby the optical pickup cannot hit the motor for rotating the optical disks, and then different types of disks can be compatible.

Three coils 32 for adjusting the position of the moving body 30 are provided on the surfaces opposite the magnets 66 when the suspension unit 61 is assembled to the actuator base 60. The magnets of the magnet portions 64 provided on the actuator base 60 and the coils 32 provided on the suspension unit 61 are arranged so as to be opposite each other. The moving body 30 can be moved by flowing an electric current to the coils.

Electricity is supplied to the coils 32 via the suspension wires 42. The coil 32 has a coil 32a for a focusing direction (the direction vertical to the surface of the optical disk) and a coil 32b for the tracking direction (the radial direction of the disk). An electric current is supplied to the coils 32 via the suspension wires 42 to finely adjust the positions in the focusing direction and the tracking direction.

The optical axes in which the optical beam 129 and the optical beam 148 or an optical beam 149 are incident on the rising prism 124 are desirably parallel with each other. By such configuration, the two reflection planes 124a and 124b of the rising prism 124 are symmetrical so that the incident angle to the objective lens can be parallel with the optical axis of the objective lens. The two reflection planes of the rising prism 124 can be symmetrical. The rising prism 124 can be manufactured more easily at low cost.

A functional operation of the optical disk device equipped with the optical pickup will be described. FIG. 7 is a block diagram noting an operation function of the optical disk device equipped with the optical pickup.

In FIG. 7, a disk motor 2 has the optical disks 180, 181, and 182 mounted on its rotating axis and rotates them at a predetermined rotational speed.

A light source 3 is a function block corresponding to the light source 121 and the second laser unit 141 shown in FIG. 3 and illuminates the optical disks 180, 181, and 182 with the laser beam (the dashed line in the drawing). An objective lens 4 focuses the illuminated laser beam onto the information recording surfaces of the optical disks 180, 181, and 182.

A photodetector 5 is a function block corresponding to the photodetector 127 and the second laser unit 141 shown in FIG. 3, and detects a reflection light of the illuminated laser beam from the optical disks 180, 181, and 182 to generate a receiving signal based on this.

The processing blocks shown below are function blocks configured as an integrated circuit mounted on this optical pickup. A disk signal detecting circuit 6 detects and computes predetermined signals recorded on the information recording surfaces of the optical disks 180, 181, and 182 based on the receiving signal generated by the photodetector 5.

A tilt actuator 7 tilts the objective lens 4 with respect to the optical axis of the laser beam. Specifically, the tilt actuator 7 is configured by the objective lens actuator 102 and notes the case of tilting the objective lens 4 (4a and 4b) of movement of the moving body 30. A tilt actuator driver 10 drives the tilt actuator 7. A tilt control circuit 9 transmits a driving signal for driving the tilt actuator 7 to the tilt actuator driver 10. A tilt computing device 8 sets the amount of the tilt as the relative tilt of the optical disks 180, 181, and 182 and the laser beam to the tilt control circuit 9.

A focus actuator 12 is a device for driving the objective lens 4 in the vertical direction with respect to the information recording surfaces of the optical disks 180, 181, and 182. Specifically, the focus actuator 12 is configured by the objective lens actuator 102 and notes the case of moving the objective lens 4 (4a and 4b) in the F axis direction of movement of the moving body 30. A focus error signal detecting circuit 13 generates the focus error signal as an error of a focal point and a predetermined position of the objective lens 4 based on the receiving signal of the photodetector 5. A focus driving signal generating circuit 14 generates a focus servo signal for focusing by the objective lens 4 onto the optical disks 180, 181, and 182 based on the output of the focus error signal detecting circuit 13. A focus actuator driver 15 drives the focus actuator 12 based on the signal transmitted from the focus driving signal generating circuit 14.

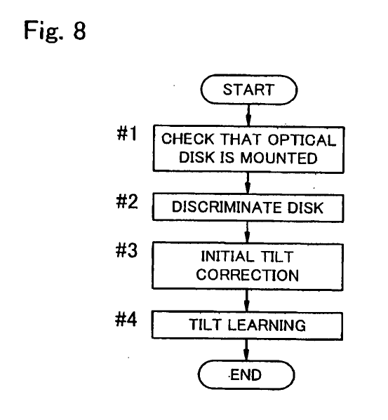

FIG. 8 is a flowchart showing the operation of the optical disk device according to the present invention of FIG. 7. The operations and features of the blocks will be specifically described according to FIG. 8.

In FIG. 8, after checking that the disk is mounted in step #1, a disk discrimination processing for discriminating the type of the disk mounted is performed in step #2.

The disk discrimination processing in step #2 will be described below in detail.

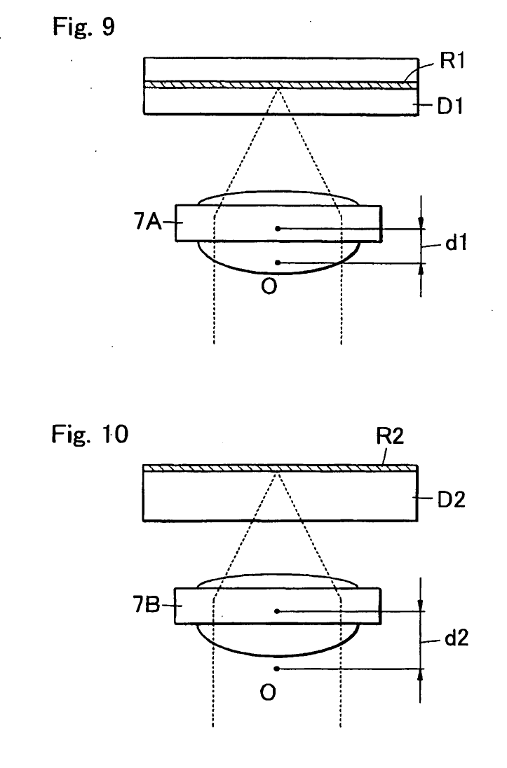

FIG. 9 is a diagram showing a positional relation between the objective lens and a first optical disk when the first optical disk is mounted to generate the focus error signal. FIG. 10 is a diagram showing a positional relation between the objective lens and a second optical disk whose protective layer thickness is different from that of the first optical disk when the second disk is mounted to generate the focus error signal. In FIGS. 9 and 10, D1 and D2 denote the substrate of the optical disk and R1 and R2 denote a reflection film layer. As shown in FIGS. 9 and 10, a distance from an optical disk surface to the reflection film layer, that is, the protective layer thickness (the substrate thickness) is different between the first disk and the second disk. A moving distance of the objective lens for matching the focal point of the optical beam with the reflection film layer of the optical disk is different, as indicated by d1 and d2.

The photodetector 5 of the optical pickup shown in FIG. 7 has the dividing sensors (not shown). The signals detected by these dividing sensors are differential-amplified by a differential amplifier of the focus error signal detecting circuit 13 to generate the focus error signal. The comparator (not shown) of the focus error signal detecting circuit 13 slices the focus error signal at an appropriate level. An S-shaped detection signal indicating that the focus error signal is detected is generated to output it to the focus driving signal generating circuit 14.

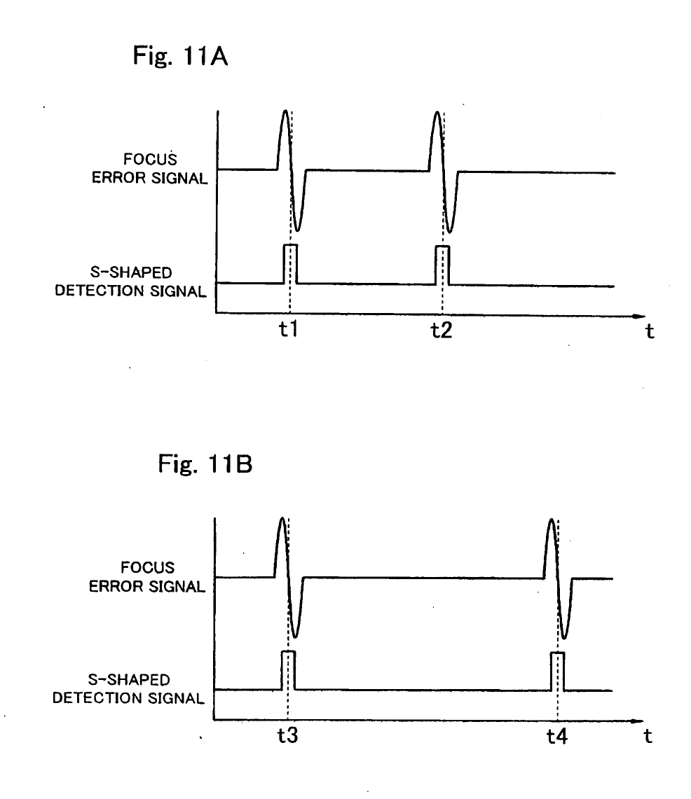

FIGS. 11A and 11B are timing charts showing the focus error signals and the S-shaped detection signals in the optical disk device shown in FIGS. 9 and 10. FIG. 11A shows waveforms of the focus error signals and the S-shaped detection signals generated when the mounted optical disk is the first disk and the objective lens is moved toward the optical disk at a fixed speed. FIG. 11B shows waveforms of the focus error signals and the S-shaped detection signals generated when the mounted optical disk is the second disk and the objective lens is moved toward the optical disk at a fixed speed.

As shown in FIGS. 11A and 11B, the focus error signal has a substantially “S”-shaped waveform. The S-shaped detection signal is generated by the comparator (not shown) of the focus error signal detecting circuit 13 of FIG. 1 and has a pulse waveform indicating focusing time. In the above-mentioned FIGS. 11A and 11B, the S-shaped detection signal at time t1 or t3 corresponds to a first focusing signal, and the S-shaped detection signal at time t2 or t4 corresponds to a second focusing signal.

As shown in FIGS. 11A and 11B, when the objective lens is gradually moved toward the optical disk from the point at time 0, the focus error signal and the S-shaped detection signal generated by reflection light on the optical disk surface for both the first disk (in the case shown in FIG. 11A) and the second disk (in the case shown in FIG. 11B) are detected at the time t1 for the first disk (in the case shown in FIG. 11A) and at the time t3 for the second disk (in the case shown in FIG. 11B)

The focus error signal and the S-shaped detection signal by reflection of the reflection film layer detected when the objective lens is moved toward the optical disk are detected at the time t2 for the first disk (in the case shown in FIG. 11A) and at the time t4 for the second disk (in the case shown in FIG. 11B) as the distance from the disk surface to the reflection film layer is different between the first disk and the second disk. The focus error signal and the S-shaped detection signal of the first disk are detected faster than those of the second disk. As shown in FIGS. 9 and 10, the distance from the disk surface to the reflection film layer, that is, the protective layer, of the first disk is shorter. A specific detection time is measured by a counter circuit 16 in FIG. 7. The type of the disk is discriminated from the difference in the protective layer thickness between the disks. This information is transmitted to a controller 17 in FIG. 7 to complete the disk discrimination processing.

In step #3 in FIG. 8, the objective lens actuator corrects for the objective lens initial tilt as the predetermined amount based on the result of the above-described disk discrimination processing.

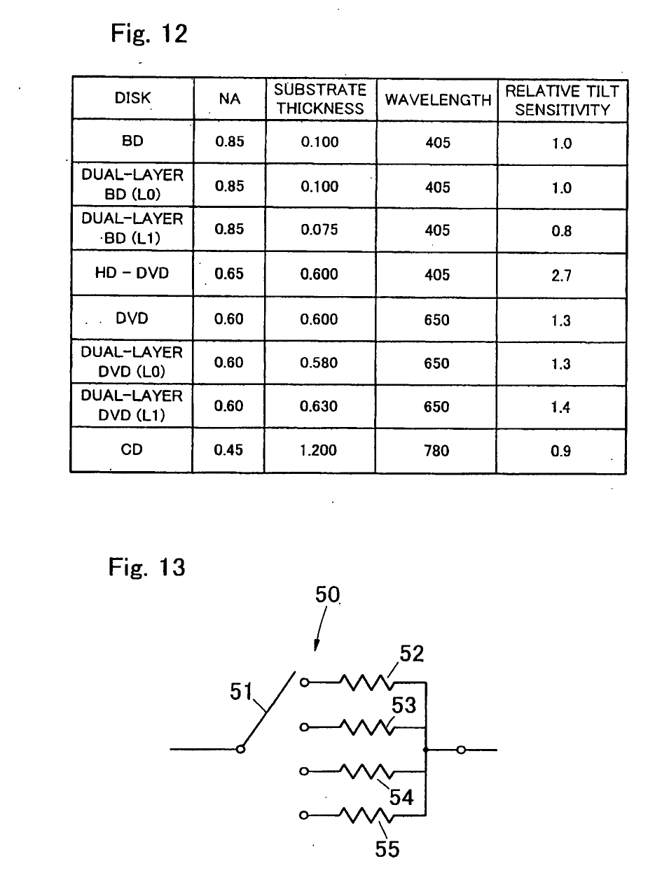

In FIG. 7, the controller 17 calls the optimum amount of the tilt correction stored in a memory 11 based on disk information and sets the offset value of a tilt control current to an offset generating circuit 18. FIG. 12 is a diagram showing the structures of information on the optimum amount of the tilt correction stored in the memory. As shown in FIG. 12, the information on the optimum amount of the tilt correction is stored as information on a relative tilt sensitivity (a single-layer BD is reference) determined according to the type of the optical disk targeted for recording or replaying. The optical disk is different depending, not only on the type of the BD, HD-DVD, DVD, and CD, but also on whether the optical disk is a single-layer disk or a dual-layer disk. In the example shown in FIG. 12, in the case of the dual-layer disk, the focal point of an optical spot as the reference of the substrate thickness measurement is set to a middle position of the first and second recording layers. The substrate thickness of the dual-layer disk is increased. The relative tilt sensitivity of the dual-layer disk is set to be smaller than that of the single-layer disk.

The offset value led from the value of the optimum amount of the tilt correction is added to the focus signal by an adder 19. The lens tilt is offset by a fixed amount.

The objective lens actuator which performs tilt control only in a radial direction in which disk tilt is likely to occur due to warping of the optical disk is often used. In many cases, most of a coma aberration of the optical system is in the objective lens.

In such case, a mark indicating a direction of the coma aberration is formed on the objective lens so as to be directed in the radial direction of the optical pickup. The coma aberration in a tangential direction can be reduced to improve a focusing characteristic of the optical system.

The optimum amount of the tilt correction is stored in the memory at an assembling adjustment of the optical pickup, which is specifically performed by the following procedure.

At the assembling adjustment of the optical pickup, the objective lens is arranged and fixed so that its optical axis is vertical to the information recording surface of a reference disk.

Each reference disk for the optical pickup is mounted, and then an offset current is flowed to the tilt driving circuit of the objective lens actuator in such a manner that coma aberration of an optical spot focused onto the reference disk is minimum.

The offset current value is an electric current value which realizes the optimum tilt correction and is temporarily stored in the memory 11.

The objective lens is arranged and fixed so that its optical axis is vertical with respect to the information recording surface of the reference disk. The objective lens may be tilted with respect to an arbitral reference disk and fixed in such a manner that the coma aberration is minimum and a relative value from the position may be stored in the memory.

When the memory is mounted on the optical pickup in the case that storing in the memory is performed at the assembling adjustment of the optical pickup, means for managing data is unnecessary. The production efficiency can be increased.

As a modification, a set value is not stored as digital information and may be set to a variable resistor of an electronic circuit mounted on the optical pickup, and the variable resistor may be switched to change the control current of the actuator. Specifically, a variable resistor 50 shown in FIG. 13 may be mounted and its switch may switch the circuit having resistances 51, 52, 53, and 54 according to the type of the discriminated optical disk to vary the resistance value at both ends of the variable resistor 50. Then, the control current of the actuator may be varied according to the value to change the tilt of the objective lens.

After the initial tilt setting in the third step has been completed, the routine is moved to a tilt learning step for adjusting the objective lens to an optimum tilt (step #4).

After focusing onto the optical disks 180, 181, and 182, the tilt computing device 8 changes the amount of the tilt stepwise with respect to the tilt control circuit 9. Then, a predetermined signal (including jitter) in the set amount of the tilt is detected by the disk signal detecting circuit 6. Thereafter, Its quadratic function is determined by computation based on the value of the predetermined signal (including jitter) detected by the disk signal detecting circuit 6, that is, the least squares method of the detection value. The optimum amount of a tilt correction is calculated based on the computed quadratic function. Thereafter, the tilt computing device 8 stores the calculated optimum amount of the tilt correction in the memory, not shown, of the controller 17 and completes a series of tilt correction processing in FIG. 8.

The jitter is detected by a high-pass filter, not shown, taking out the high frequency component of a signal, a wave detector, not shown, detecting the output signal of the high-pass filter, and jitter detection means constituted by an A/D converter, not shown, digitalizing the output signal of the wave detector.

The method of performing tilt learning based on a signal quality of reflection light from the disk has high accuracy and is complex in steps. As a simplified method, a method of performing tilt learning by detecting warping of the disk is used.

As a specific method, the objective lens is moved to a first position of the optical information medium in the radial direction to adjust a focusing position for focusing onto a signal surface of the optical information medium, and the objective lens is moved to a second position of the optical information medium in the radial direction to adjust the focusing position for focusing onto the signal surface of the optical information medium, and then the tilt of the optical information medium with respect to the optical axis of the optical pickup is computed and detected from the first and second positions and the focusing positions in the first and second positions.

The angle of the optical information medium with respect to the optical axis of the optical pickup is adjusted according to the computation result.

In either method, the optimum amount of the tilt correction is recorded into the controller 17, together with information in the radial position of the disk (e.g., including disk layer information) to which the tilt adjustment step is executed.

In the recording or replaying operation of the optical disk device, the tilt computing device 8 calls the optimum amount of the tilt correction stored in the controller 17. The amount of the tilt of the objective lens 4 is optimally adjusted based on the stored optimum amount of the tilt correction via the tilt control circuit 9, the tilt actuator driver 10, and the tilt actuator 7. Then the predetermined recording or replaying operation is executed with respect to the optical disk.

In this case, the predetermined signal of the disk signal detecting circuit 6 used for determining the optimum amount of the tilt correction is any one of a replaying signal, Wobble signal, and tracking error signal. The computation value based on the predetermined signal of the disk signal detecting circuit 6 is any one of a jitter, error rate, replaying signal amplitude, Wobble signal amplitude, and tracking error signal amplitude.

In this embodiment, the initial tilt correction in step #3 and the tilt learning in step #4 are processed in that order. However, the tilt learning and the initial tilt correction may be processed in that order. When the tilt learning is performed, the correction value of the initial tilt correction can be increased or decreased to adjust the amount of correction of the tilt learning.

The steps in this present embodiment are realized by one integrated circuit. The optical pickup can be smaller and lightweight.

### SECOND EMBODIMENT

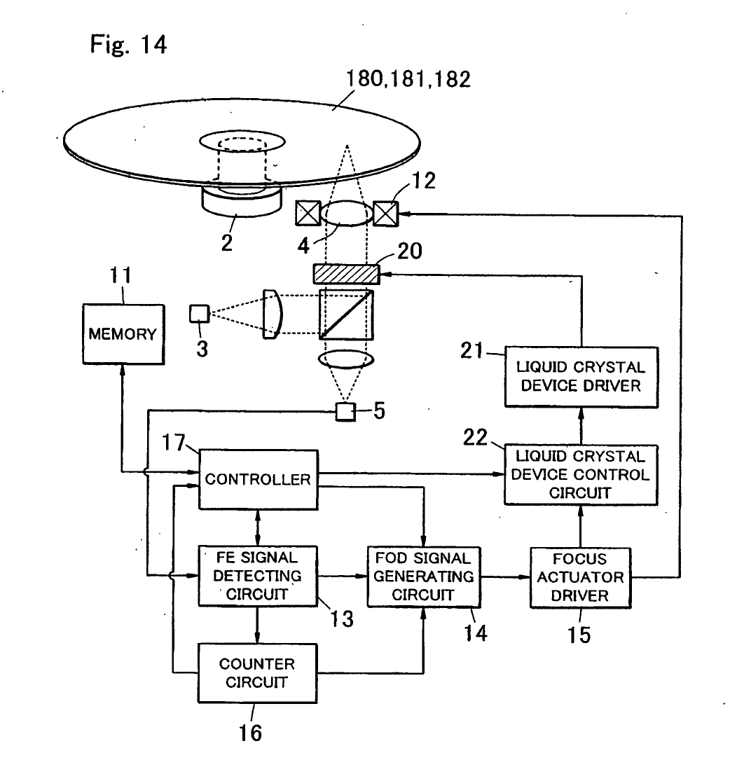

FIG. 14 is a block diagram noting an operation function of an optical disk device according to a second embodiment.

Unlike the optical disk device shown in FIG. 7, in the optical disk device according to this embodiment, a liquid crystal aberration correction device 20 having a function of correcting for aberration of the optical system is arranged in place of the tilt actuator. That is, in the optical disk device according to this embodiment, the objective lens actuator 102 can be moved in the focus and tracking directions and need not have the configuration capable of tilting the optical axis of the objective lens.

The liquid crystal aberration correction device 20 is controlled by a liquid crystal device control circuit 22 by an instruction from the controller 17 and is driven by a liquid crystal device driver 21.

In the optical disk device according to this embodiment, the operations of the respective blocks are performed according to the flow of FIG. 8 except that the initial tilt correction in step #3 and the tilt learning in step #4 are performed by controlling the liquid crystal aberration correction device 20.

In place of correcting for the objective lens initial tilt as the predetermined amount by the objective lens actuator based on the result of the disk discrimination processing obtained from the same processing as the first embodiment, the liquid crystal aberration correction device 20 corrects for the coma aberration of the optical system as the predetermined amount based on the result of the disk discrimination processing.

The amount of the coma aberration correction of the optical system is stored in the memory at the assembling adjustment of the optical pickup, which is specifically performed in the following procedure.

At the assembling adjustment of the optical pickup, the objective lens is arranged and fixed so that its optical axis is vertical to the information recording surface of the reference disk.

Each reference disk for the optical pickup is mounted. The control voltage of the liquid crystal aberration correction device 20 is changed in such a manner that coma aberration of an optical spot focused onto the reference disk is minimum.

The control voltage value is a voltage value which realizes the optimum coma aberration correction and is stored in the memory.

The objective lens is arranged and fixed so that its optical axis is vertical to the information recording surface of the reference disk. However, the objective lens may be tilted with respect to an arbitral reference disk and fixed in such a manner that the coma aberration is minimum and the control voltage value in the position may be stored in the memory.

The set value is not stored as digital information. The set value is set to a variable resistor of an electronic circuit mounted on the optical pickup. The variable resistor may be switched to change the control voltage of the liquid crystal aberration correction device 20.

After the initial tilting setting in the third step has been completed, the routine is moved to the tilt learning step for minimizing coma aberration caused on an optical spot focused onto the optical disk from the objective lens by the tilt of the optical disk (step #4).

After focusing onto the optical disks 180, 181, and 182, the liquid crystal aberration correction device controller 22 applies a voltage stepwise to the liquid crystal aberration correction device and changes stepwise the coma aberration of the optical spot focused onto the optical disk from the objective lens. Then a predetermined signal (including jitter) in the set coma aberration is detected by the disk signal detecting circuit 6. Its quadratic function is determined by computation based on the value of the predetermined signal (including jitter) detected by the disk signal detecting circuit 6, that is, the least squares method of the detection value. The optimum amount of coma aberration correction is calculated based on the computed quadratic function. Thereafter, the liquid crystal aberration correction device controller 22 stores the calculated optimum amount of coma aberration correction in the controller 17 and completes the processing.

In the recording or replaying operation of the optical disk device, the liquid crystal aberration correction device controller 22 calls the optimum amount of the coma aberration correction stored in the controller 17. The coma aberration of the emitted light of the objective lens is optimally adjusted based on the stored optimum amount of the coma aberration correction by the liquid crystal aberration correction device controller 22, the liquid crystal aberration correction device driver 21, and the liquid crystal aberration correction device 20. Then the predetermined recording or replaying operation is executed to the optical disk.

Other operation processing is the same as the first embodiment.

In this embodiment, the liquid crystal aberration correction device 20 corrects for the coma aberration of the optical system as the predetermined amount based on the result of the disk discrimination processing and may correct for other aberration, such as an astigmatism and a spherical aberration, in the same manner.

In this embodiment, the initial tilt correction in step #3 and the tilt learning in step #4 are processed in that order. The tilt learning and the initial tilt correction may be processed in that order. When the tilt learning is performed, the correction value of the initial tilt correction can be increased or decreased to adjust the amount of correction of the tilt learning.

### THIRD EMBODIMENT

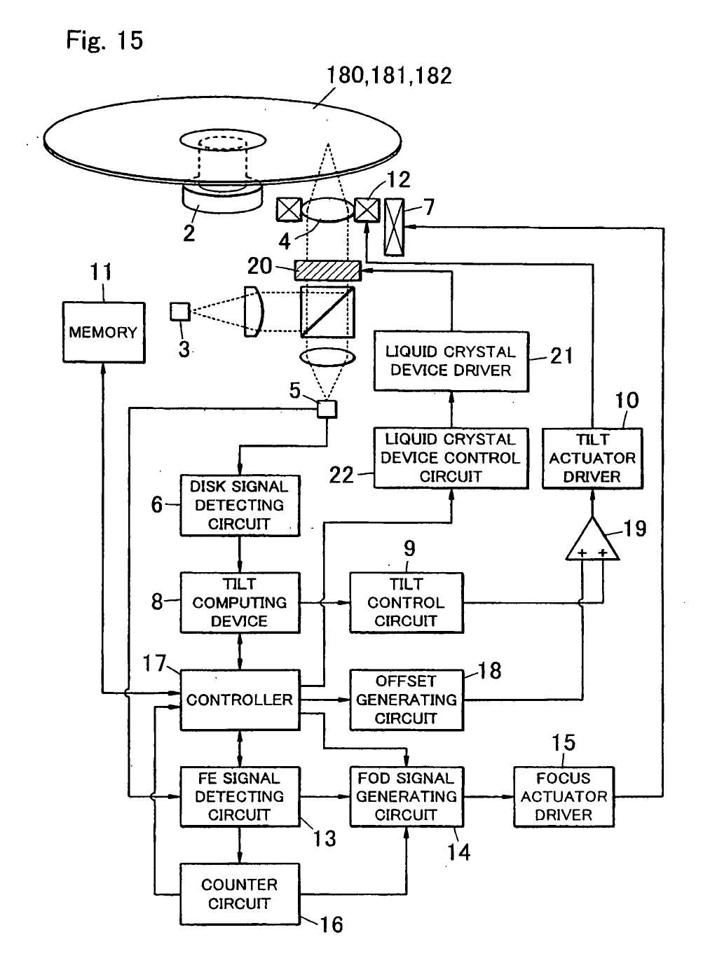

FIG. 15 is a block diagram noting an operation function of an optical disk device according to a third embodiment.

Unlike the optical disk device shown in FIG. 7 and the optical disk device shown in FIG. 14, in the optical disk device according to the present embodiment, the tilt actuator and the liquid crystal aberration correction device 20 are arranged at the same time.

The operations of the blocks are performed according to the flow of FIG. 8. However, the initial tilt correction in step #3 and the tilt learning in step #4 are performed by controlling the tilt actuator 7, or the liquid crystal aberration correction device 20, or the tilt actuator 7 and the liquid crystal aberration correction device 20, at the same time.

Other contents are similar to the optical disk device shown in FIG. 7 and the optical disk device shown in FIG. 14.

### FOURTH EMBODIMENT

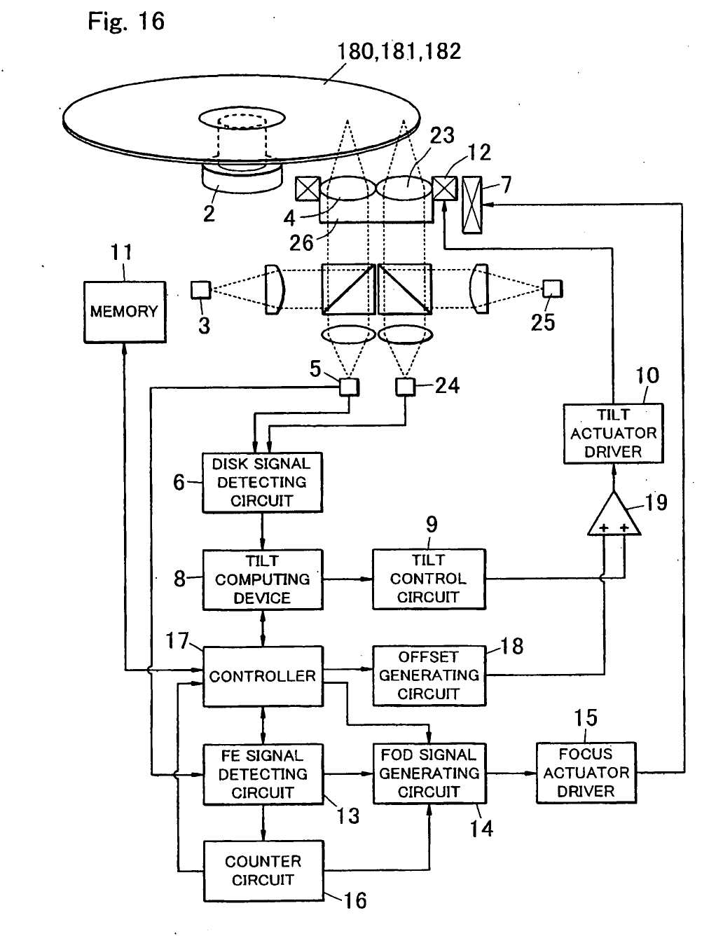

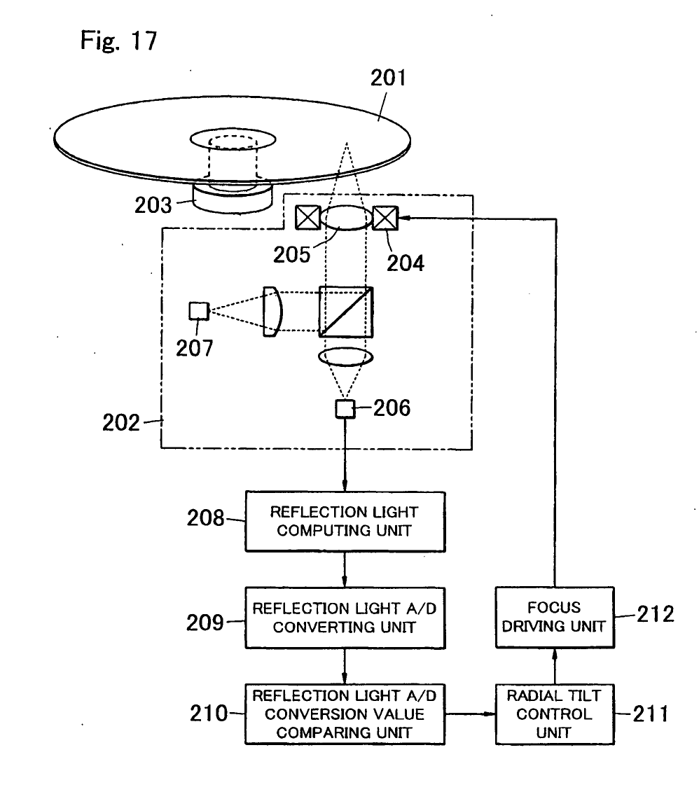

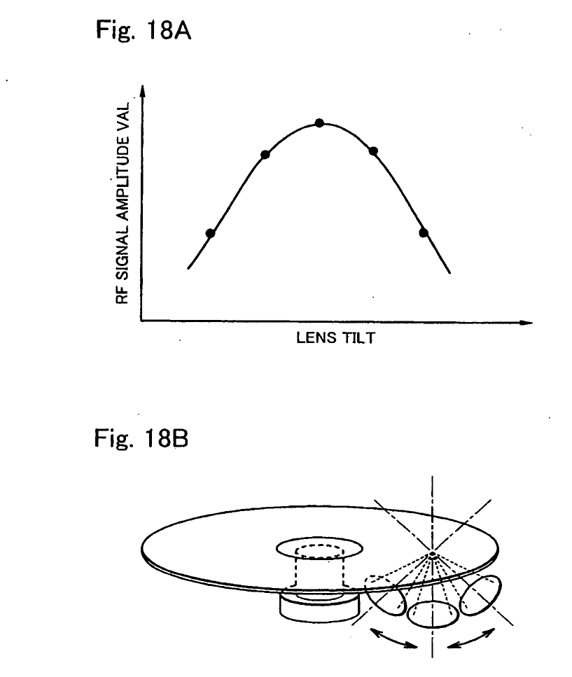

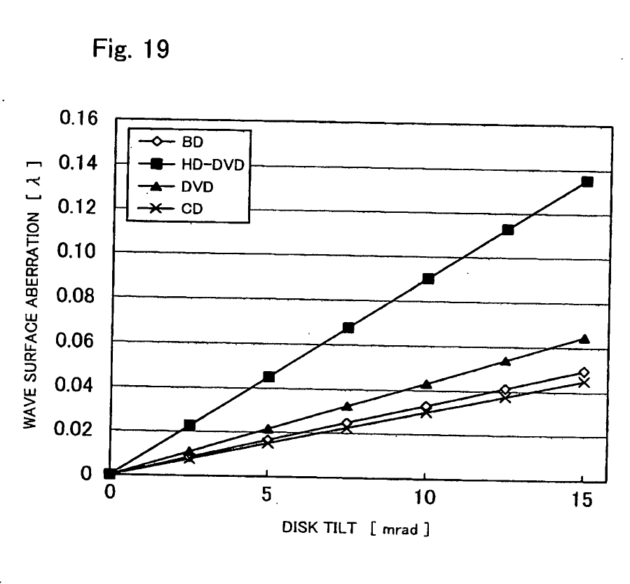

FIG. 16 is a block diagram noting an operation function of an optical disk device according to a fourth embodiment.

In the optical disk devices shown in the above-described FIGS. 7, 14, and 15, only one objective lens and only one light source are shown. However, the specific configuration when two or more light sources and objective lenses are mounted on the optical pickup shown in FIG. 1 is shown.

As the specific configuration example in the drawing, as described above, the first laser 3 is a bluish purple laser having a wavelength of 405 nm, and a second laser 25 is a red laser. Recording or replaying is performed to the Blu-ray disk and the HD-DVD disk by the first objective lens 4. Recording or replaying is performed to the DVD and the CD by a second objective lens 23.

As other combinations, there are considered a configuration in which recording or replaying is performed to the Blu-ray disk using the first light source and the first objective lens and recording or replaying is performed to the HD-DVD, DVD, and CD using the shared second objective lens, and a configuration in which recording or replaying is performed to the Blu-ray disk, HD-DVD, DVD, and CD using a shared objective lens.

Other contents are similar to the optical disk device shown in FIG. 7, the optical disk device shown in FIG. 14, and the optical disk device shown in FIG. 15.

An optical pickup and an optical information recording/replaying device of the present invention are useful for a magneto optic recording device and an optical information recording/replaying device using an optical disk, such as a CD, DVD, HD-DVD, and Blu-ray disk device. The optical pickup and the optical information recording/replaying device of the present invention are applicable to an optical system or a device of a hologram recording device and a future superdense recording/replaying device.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. An optical pickup for performing recording or replaying to a plurality types of optical information media, comprising:
one or a plurality of light sources;
an objective lens for focusing light from the light source onto the optical information medium;
an objective lens actuator for moving the objective lens in a focus direction and in a tracking direction and changing a tilt of an optical axis of the objective lens;
an optical information medium discriminating unit for discriminating the type of the optical information medium at a start of recording or replaying to the optical information medium;
a tilt angle storing unit having tilt information having information on the tilt of the objective lens according to the type of the optical information medium; and
an objective lens tilt setting unit for driving and controlling the objective lens actuator so as to tilt the objective lens to an angle set based on the tilt information of the tilt angle storing unit based on the discriminated result of the type of the optical information medium by the optical information medium discriminating unit.

2. The optical pickup according to claim 1, further comprising:
a driving state detecting unit for detecting a recording or replaying state of the optical information medium; and
a tilt correction control unit for driving and controlling the objective lens actuator so as to tilt the objective lens according to the driving state by the driving state detecting unit.

3. The optical pickup according to claim 1, wherein recording or replaying is performed to the optical information media as a first optical disk having a numerical aperture of 0.85 and a substrate thickness of 0.1 mm and a second optical disk having a numerical aperture of 0.65 and a substrate thickness of 0.6 mm using a shared light source and a shared objective lens.

4. The optical pickup according to claim 1,
wherein a plurality of the objective lenses are provided corresponding to the plurality of light sources,
wherein recording or replaying is performed to the first optical disk having a numerical aperture of 0.85 and a substrate thickness of 0.1 mm and the second optical disk having a numerical aperture of 0.65 and a substrate thickness of 0.6 mm using a first light source and a first objective lens, and
wherein recording or replaying is performed to a third optical disk having a numerical aperture of 0.60 and a substrate thickness of 0.6 mm and a fourth optical disk having a numerical aperture of 0.45 and a substrate thickness of 1.2 mm using a second light source and a second objective lens.

5. The optical pickup according to claim 1,
wherein a plurality of the objective lenses are provided corresponding to the plurality of light sources,
wherein recording or replaying is performed to the first optical disk having a numerical aperture of 0.85 and a substrate thickness of 0.1 mm using the first light source and the first objective lens, and
wherein recording or replaying is performed to the second optical disk having a numerical aperture of 0.65 and a substrate thickness of 0.6 mm, the third optical disk having a numerical aperture of 0.60 and a substrate thickness of 0.6 mm, and the fourth optical disk having a numerical aperture of 0.45 and a substrate thickness of 1.2 mm using the second light source and the second objective lens.

6. An optical disk drive using the optical pickup according to claim 1.

7. An optical information recording/replaying device using the optical disk drive according to claim 6.

8. A tilt adjusting method of adjusting the tilt angle of the objective lens using the optical pickup according to claim 2, comprising:
discriminating a type of an optical information medium by the optical information medium discriminating unit before recording or replaying is performed to the optical information medium;
reading tilt information as information on the tilt of the objective lens according to the type of the optical information medium stored in the tilt angle storing unit;
tilting the objective lens to an angle set based on the tilt information of the tilt angle storing unit based on the discriminated result of the type of the optical information medium;
detecting the recording or replaying state after a start of recording or replaying to the optical information medium; and
driving and controlling the objective lens actuator so as to adjust the tilt of the objective lens according to the detected recording or replaying state of the optical information medium.

9. A tilt adjusting method of adjusting the tilt angle of the objective lens using the optical pickup according to claim 2, comprising:
discriminating a type of an optical information medium by the optical information medium discriminating unit when recording or replaying is performed to the optical information medium;
reading tilt information stored in the tilt angle storing unit;
detecting the recording or replaying state of the optical information medium; and
driving and controlling the objective lens actuator so as to correct for and adjust the tilt of the objective lens by increasing and decreasing the amount of the tilt indicated by the read tilt information in driving and controlling the objective lens according to the detected recording or replaying state of the optical information medium.

10. An optical pickup for performing recording or replaying to a plurality of types of optical information media, comprising:
one or a plurality of light sources;
an objective lens for focusing light from the light source onto the optical information medium;
an objective lens actuator for moving the objective lens in a focus direction and in a tracking direction;
an optical information medium discriminating unit for discriminating the type of the optical information medium at a start of recording or replaying to the optical information medium;
an aberration correction device for correcting for aberration of light emitted from the objective lens;
an aberration correction value storing unit having aberration information storing information on the correction value of the aberration of the light according to the type of the optical information medium; and
a coma aberration setting unit for offsetting a coma aberration of the emitted light of the objective lens by a fixed amount by driving and controlling the aberration correction device to the correction value set by the aberration information of the aberration correction value storing unit based on the discriminated result of the type of the optical information medium by the optical information medium discriminating unit.

11. The optical pickup according to claim 10, further comprising:
a driving state detecting unit for detecting a recording or replaying state of the optical information medium; and
a coma aberration correcting unit for offsetting the coma aberration of the emitted light of the objective lens by a fixed amount by driving and controlling the aberration correction device according to the driving state by the driving state detecting unit.

12. The optical pickup according to claim 10, wherein the aberration correction device is constituted by a liquid crystal device.

13. The optical pickup according to claim 12, wherein the liquid crystal device can correct for both the coma aberration and a spherical aberration according to the type of the optical information medium.

14. A tilt adjusting method of correcting for a coma aberration of the emitted light of the objective lens using the optical pickup according to claim 11, comprising:
discriminating a type of an optical information medium by the optical information medium discriminating unit before recording or replaying is performed to the optical information medium;
reading information on the correction value of the aberration of the light according to the type of the optical information medium stored in the aberration correction value storing unit;
driving and controlling the aberration correction device to the correction value set based on the correction value of the aberration of the aberration correction value storing unit based on the discriminated result of the type of the optical information medium;
detecting the recording or replaying state after a start of recording or replaying to the optical information medium; and
offsetting the coma aberration of the emitted light of the objective lens by a fixed amount by driving and controlling the aberration correction device according to the detected recording or replaying state of the optical information medium.

15. A tilt adjusting method of correcting for the coma aberration of the emitted light of the objective lens using the optical pickup according to claim 11, comprising:
discriminating a type of an optical information medium by the optical information medium discriminating unit when recording or replaying is performed to the optical information medium;
reading information on the correction value of the aberration of the light according to the type of the optical information medium stored in the aberration correction value storing unit;
detecting the recording or replaying state after a start of recording or replaying to the optical information medium; and
offsetting the coma aberration of the emitted light of the objective lens by a fixed amount by driving and controlling the aberration correction device by increasing and decreasing the amount based on the read correction value in driving and controlling the objective lens according to the detected recording or replaying state of the optical information medium.

16. An optical pickup for performing recording or replaying to a plurality of types of optical information media, comprising:
one or a plurality of light sources;
an objective lens for focusing light from the light source onto the optical information medium;
an objective lens actuator for moving the objective lens in a focus direction and in a tracking direction and changing a tilt of the optical axis of the objective lens;
an optical information medium discriminating unit for discriminating the type of the optical information medium at a start of recording or replaying to the optical information medium;
a tilt angle storing unit having tilt information having information on the tilt of the objective lens according to the type of the optical information medium;
an objective lens tilt setting unit for driving and controlling the objective lens actuator so as to tilt the objective lens to an angle set based on the tilt information of the tilt angle storing unit based on the discriminated result of the type of the optical information medium by the optical information medium discriminating unit;
a driving state detecting unit for detecting the recording or replaying state of the optical information medium; and
a coma aberration correcting unit for offsetting the coma aberration of the emitted light of the objective lens by a fixed amount by driving and controlling the aberration correction device according to the driving state by the driving state detecting unit.

17. A tilt adjusting method of adjusting the tilt angle of the objective lens using the optical pickup according to claim 16, comprising:
discriminating a type of an optical information medium by the optical information medium discriminating unit before recording or replaying is performed to the optical information medium;
reading tilt information as information on the tilt of the objective lens according to the type of the optical information medium stored in the tilt angle storing unit;
tilting the objective lens to an angle set based on the tilt information of the tilt angle storing unit based on the discriminated result of the type of the optical information medium;
detecting the recording or replaying state after a start of recording or replaying to the optical information medium; and
offsetting the coma aberration of the emitted light of the objective lens by a fixed amount by driving and controlling the aberration correction device according to the detected recording or replaying state of the optical information medium.

18. A tilt adjusting method of adjusting the tilt angle of the objective lens using the optical pickup according to claim 16, comprising:
discriminating a type of an optical information medium by the optical information medium discriminating unit when recording or replaying is performed to the optical information medium;
reading tilt information stored in the tilt angle storing unit;
detecting the recording or replaying state of the optical information medium; and
offsetting the coma aberration of the emitted light of the objective lens by a fixed amount by driving and controlling the aberration correction device by increasing and decreasing the amount of the tilt indicated by the read tilt information in driving and controlling the objective lens according to the detected recording or replaying state of the optical information medium.

19. An optical pickup for performing recording or replaying to a plurality of types of optical information media, comprising:
one or a plurality of light sources;
an objective lens for focusing light from the light source onto the optical information medium;
an objective lens actuator for moving the objective lens in a focus direction and in a tracking direction and change a tilt of the optical axis of the objective lens;
an optical information medium discriminating unit for discriminating the type of the optical information medium at a start of recording or replaying to the optical information medium;
an aberration correction device for correcting for aberration of light emitted from the objective lens;
an aberration correction value storing unit having aberration information storing information on the correction value of the aberration of the light according to the type of the optical information medium;
a driving state detecting unit for detecting the recording or replaying state of the optical information medium; and
a tilt correction control unit for driving and controlling the objective lens actuator so as to tilt the objective lens according to the driving state by the driving state detecting unit.

20. A tilt adjusting method of adjusting the tilt angle of the objective lens using the optical pickup according to claim 19, comprising:
discriminating a type of an optical information medium by the optical information medium discriminating unit before recording or replaying is performed to the optical information medium;
reading information on the correction value of the aberration of the light according to the type of the optical information medium stored in the aberration correction value storing unit;
driving and controlling the aberration correction device to the correction value set based on the correction value of the aberration of the aberration correction value storing unit based on the discriminated result of the type of the optical information medium;
detecting the recording or replaying state after a start of recording or replaying to the optical information medium; and
driving and controlling the objective lens actuator so as to adjust the tilt of the objective lens according to the detected recording or replaying state of the optical information medium.

21. A tilt adjusting method of adjusting the tilt angle of the objective lens using the optical pickup according to claim 19, comprising:
discriminating a type of an optical information medium by the optical information medium discriminating unit when recording or replaying is performed to the optical information medium;
reading information on the correction value of the aberration of the light according to the type of the optical information medium stored in the aberration correction value storing unit;
detecting the recording or replaying state after a start of recording or replaying to the optical information medium; and
driving and controlling the objective lens actuator so as to correct for and adjust the tilt of the objective lens by increasing and decreasing the amount of tilt indicated by the read information on the correction value of the aberration of the light in driving and controlling the objective lens according to the detected recording or replaying state of the optical information medium.

22. The optical pickup according to claim 1,
wherein the optical information medium discriminating unit comprises:
a signal processing unit for detecting a first focusing signal indicating that the optical beam is focused near a surface of the optical information medium and a second focusing signal indicating that the optical beam is focused near the reflection film layer, by a reflection light from the optical information medium detected by the optical pickup;
a counting unit for measuring an elapsed time from a detection point of the first focusing signal to a detection point of the second focusing signal when the objective lens is moved toward the optical information medium by the objective lens actuator; and
a discriminating unit for discriminating the type of the optical information medium based on the elapsed time.

23. The optical pickup according to claim 21, wherein the discriminating unit compares a predetermined reference value with the value of the elapsed time to discriminate the type of the optical information medium based on the result of the comparison.
